(19) United States
(12) Patent Application Publication
(10) Pub. No.: US 2026/0156495 A1
(43) Pub. Date: Jun. 4, 2026

(54) Methods And Apparatus For Requesting Configuration Update In Mobile Communications

(71) Applicant: MediaTek Inc., Hsinchu City (TW)

(72) Inventors: Chin-Te Chen, Hsinchu City (TW); Ren-Huang Liu, Hsinchu City (TW); Pan-Yen Chiang, Hsinchu City (TW)

(73) Assignee: MediaTek Inc., Hsinchu City (TW)

(21) Appl. No.: 19/398,115

(22) Filed: Nov. 24, 2025

Related U.S. Application Data
(60) Provisional application No. 63/726,629, filed on Dec. 1, 2024.

(51) Int. Cl. H04W 24/02; H04W 60/06

(52) U.S. Cl. CPC H04W 24/02; H04W 60/06

(57) ABSTRACT

Various solutions for requesting configuration update with respect to an apparatus and a network are described. An apparatus may transmit a request message to a network to request configuration update command (CUC) information. The apparatus may receive a CUC message with the CUC information from the network. The apparatus may transmit a configuration update complete message to the network.

### CROSS REFERENCE TO RELATED PATENT APPLICATION(S)

The present disclosure is part of a non-provisional application claiming the priority benefit of U.S. Patent Application Ser. No. 63/726,629, filed 1 Dec. 2024. The content of which is herein incorporated by reference in its entirety.

### TECHNICAL FIELD

The present disclosure is generally related to mobile communications and, more particularly, to requesting configuration update with respect to an apparatus and a network node in mobile communications.

### BACKGROUND

Unless otherwise indicated herein, approaches described in this section are not prior art to the claims listed below and are not admitted as prior art by inclusion in this section.

Wireless communication systems may be widely deployed to provide various telecommunication services such as telephony, video, data, messaging, and broadcasts. Typical wireless communication systems may use multiple-access technologies capable of supporting communication with multiple users by sharing available system resources. Examples of such multiple-access technologies may include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

In conventional communication technologies, the user equipment (UE) configuration may be updated by the network at any time through the UE configuration update procedure. However, the UE does not know when the UE configuration update command can send the time zone or other related information. For example, the regional network identity time zone (NITZ) and the operation name information. The UE may not know when the command of the AMF will come after the registration procedure. Therefore, the local time zone or the network name could be incorrect for some period.

Accordingly, how to request configuration update for obtaining correct information becomes an important issue for the newly developed wireless communication network. Therefore, there is a need to provide proper schemes for requesting configuration update.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods, and apparatus pertaining to requesting configuration update with respect to an apparatus and a network node in mobile communications. It is believed that the above-described issue would be avoided or otherwise alleviated by implementing one or more of the proposed schemes described herein.

In one aspect, a method may involve an apparatus transmitting a request message to a network to request configuration update command (CUC) information. The method may also involve the apparatus receiving a CUC message with the CUC information from the network. The method may further involve the apparatus transmitting a configuration update complete message to the network.

In another aspect, a method may involve a network node receiving a request message for requesting configuration update command (CUC) information from a user equipment (UE). The method may also involve the network node transmitting a CUC message with the CUC information based on the request message to the UE. The method may further involve the network node receiving a configuration update complete message from the UE.

In another aspect, an apparatus may involve a transceiver which, during operation, wirelessly communicates with at least one network node of a wireless network. The apparatus may also involve a processor communicatively coupled to the transceiver such that, during operation, the processor may transmit, via the transceiver, a request message to a network to request CUC information. The processor may also receive, via the transceiver, a CUC message with the CUC information from the network. The processor may further transmit, via the transceiver, a configuration update complete message to the network.

It is noteworthy that, although description provided herein may be in the context of certain radio access technologies, networks and network topologies such as 5^{th} Generation System (5GS) and 4G EPS mobile networking, the proposed concepts, schemes and any variation(s)/derivative(s) thereof may be implemented in, for and by other types of wireless and wired communication technologies, networks and network topologies such as, for example and without limitation, Ethernet, Universal Terrestrial Radio Access Network (UTRAN), E-UTRAN, Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (IIoT), Narrow Band Internet of Things (NB-IoT), 6th Generation (6G), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario for requesting configuration under the first proposed scheme, with the request message transmitted in the RM-registered state, in accordance with implementations of the present disclosure.

FIG. 3 is a diagram depicting an example scenario for requesting configuration, with the request message transmitted in the RM-deregistered state, in accordance with implementations of the present disclosure.

FIG. 4 is a diagram depicting an example scenario for a payload container type IE in accordance with implementations of the present disclosure.

FIG. 5 is a diagram depicting an example scenario for the request CSC parameter container in accordance with implementations of the present disclosure.

FIG. 6 is a diagram depicting an example scenario for requesting configuration under the second proposed scheme, with the request message transmitted in the RM-registered state, in accordance with implementations of the present disclosure.

FIG. 7 is a diagram depicting an example scenario for the configuration update request message in accordance with implementations of the present disclosure.

FIG. 8 is a diagram depicting an example scenario for the request configuration update parameters information element in accordance with implementations of the present disclosure.

FIG. 9 is a diagram depicting an example scenario for the request configuration update procedure in accordance with implementations of the present disclosure.

FIG. 10 is a block diagram of an example communication system in accordance with an implementation of the present disclosure.

FIG. 11 is a flowchart of an example process in accordance with an implementation of the present disclosure.

FIG. 12 is a flowchart of an example process in accordance with another implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes, and/or solutions pertaining to requesting configuration update with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

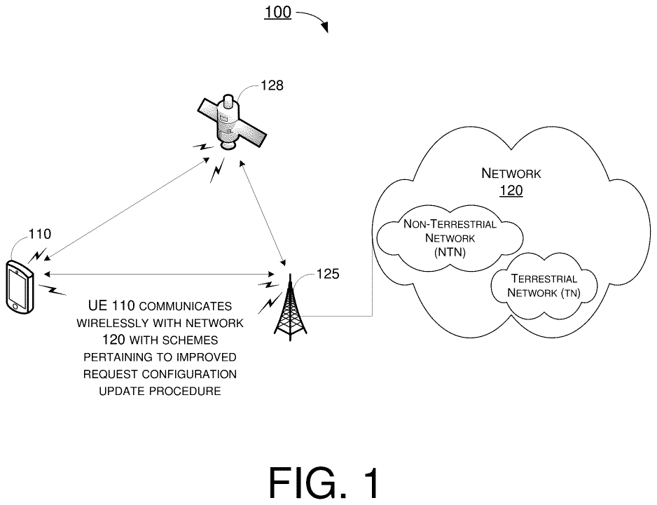

FIG. 1 illustrates an example scenario 100 of a communication environment in which various solutions and schemes in accordance with the present disclosure may be implemented. Scenario 100 involves a UE 110 in wireless communication with a network 120 (e.g., a wireless network including an NTN and a TN) via a terrestrial network node 125 (e.g., an evolved Node-B (eNB), a Next Generation Node-B (gNB), or a transmission/reception point (TRP)) and/or a non-terrestrial network node 128 (e.g., a satellite). For example, the terrestrial network node 125 and/or the non-terrestrial network node 128 may form a non-terrestrial network (NTN) serving cell for wireless communication with the UE 110. In some implementations, the UE 110 may be an IoT device such as an NB-IoT UE or an enhanced machine-type communication (eMTC) UE (e.g., a bandwidth reduced low complexity (BL) UE or a coverage enhancement (CE) UE). In such a communication environment, the UE 110, the network 120, the terrestrial network node 125, and the non-terrestrial network node 128 may implement various schemes pertaining to improved request configuration update procedure in accordance with the present disclosure, as described below. It is noteworthy that, while the various proposed schemes may be individually or separately described below, in actual implementations, some or all of the proposed schemes may be utilized or otherwise implemented jointly. Of course, each of the proposed schemes may be utilized or otherwise implemented individually or separately.

According to the implementations of the present disclosure, an apparatus (e.g., UE 110) may transmit a request message to a network (e.g., network 120) (or to an access and mobility management function (AMF) of the network) to request configuration update command (CUC) information. The apparatus may receive a CUC message (e.g., UE configuration update command) with the CUC information from the network (or the AMF). Then, the apparatus may transmit a configuration update complete message (e.g., UE configuration complete) to the network (or the AMF).

According to the implementations of the present disclosure, the request message may be transmitted in an RM-registered state, and the CUC message may be received in a mobility management (MM)-registered state (e.g., fifth-generation MM (5GMM) registered state or sixth-generation MM (6GMM) registered state).

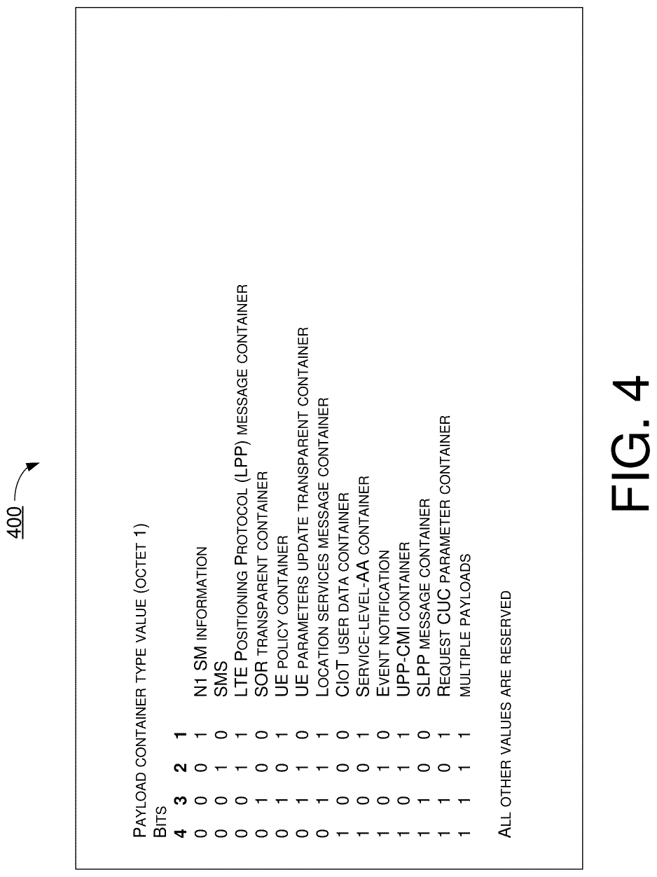

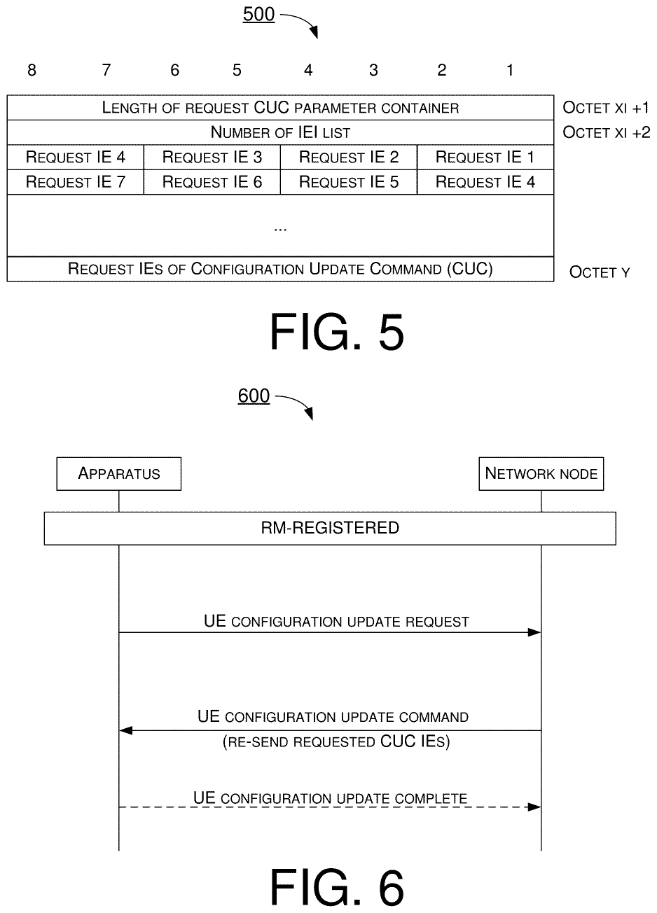

Under a first proposed scheme for the request message transmitted in an RM-registered state, the request message may comprise an uplink (UL) non-access stratum (NAS) transport message, and the UL NAS transport message may comprise a request list of information element identifier (IEI) values in a request CUC parameter container (e.g., the table shown in FIG. 5). In an implementation, a payload container type information element (IE) (e.g., the table shown in FIG. 4) may comprise the request CUC parameter container. Specifically, the apparatus may transmit a list of request information in the payload container type set to the request CUC parameter container. The request list of IEI values specified in the request CUC parameters container may be an identical list of information assigned in the configuration update command from the network node (e.g., the AMF of the network). In an event that the network node (e.g., the AMF of the network) receives the request CUC parameter container in the payload container IE of the UL NAS transport message in the MM-registered state, the network node (e.g., the AMF of the network) may transmit the CUC message (e.g., UE configuration update command) according to the UL NAS transport message. That is, the CUC message (e.g., UE configuration update command) may comprise the request information in the UL NAS transport message.

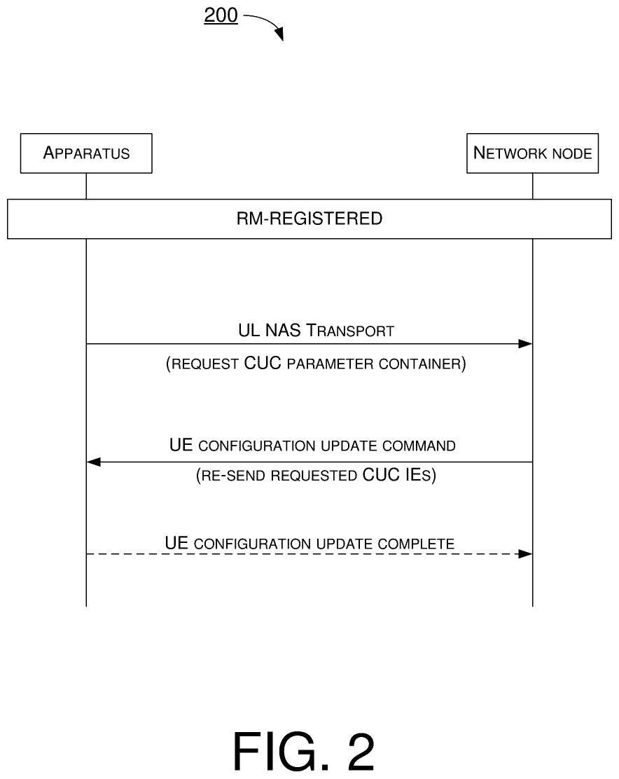

FIG. 2 illustrates an example scenario 200 for requesting configuration under the first proposed scheme, with the request message transmitted in the RM-registered state, in accordance with implementations of the present disclosure. Scenario 200 involves an apparatus (e.g., a UE) and a network node (e.g., a (macro/micro) base station) which may be an AMF of a wireless network (e.g., an LTE network, a 5G/NR network, an IoT network, or a 6G network). Referring to FIG. 2, in the RM-registered state, the apparatus may transmit the UL NAS transport message with the request CUC parameter container. Then, the AMF may transmit the CUC message (e.g., UE configuration update command) according to the UL NAS transport message. That is, the AMF may re-transmit the requested CUC IEs to the apparatus. Then, the apparatus may transmit the configuration update complete message (e.g., UE configuration update complete) to the AMF.

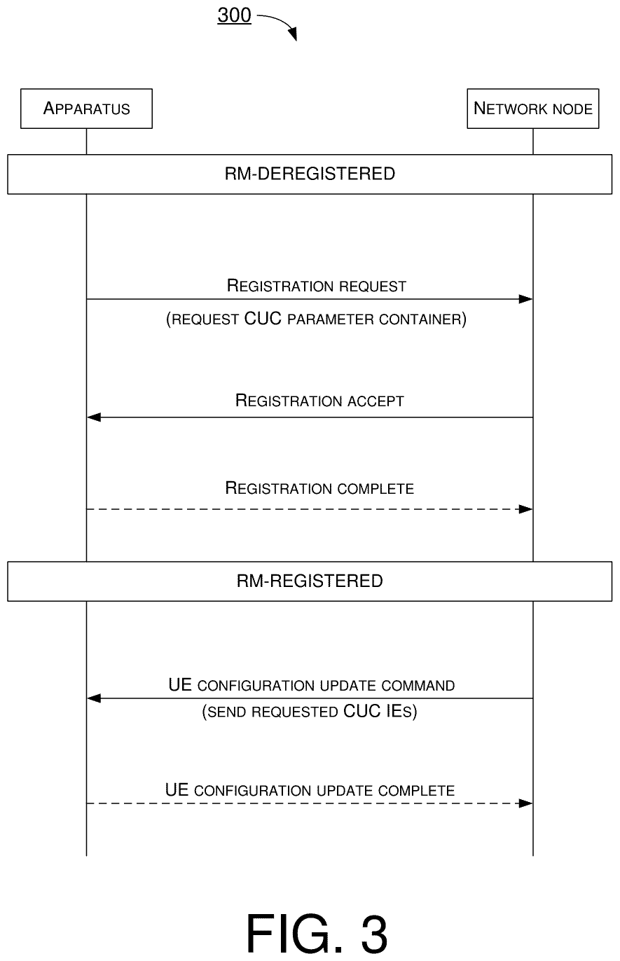

FIG. 3 illustrates an example scenario 300 for requesting configuration, with the request message transmitted in the RM-deregistered state, in accordance with implementations of the present disclosure. Scenario 300 involves an apparatus (e.g., a UE) and a network node (e.g., a (macro/micro) base station) which may be an AMF of a wireless network (e.g., an LTE network, a 5G/NR network, an IoT network, or a 6G network). Referring to FIG. 3, in the RM-deregistered state, the apparatus may transmit a registration request message (e.g., registration request or initial registration request) with the request CUC parameter container to the AMF. Then, the AMF may transmit a registration accept message (e.g., registration accept) to the apparatus. Then, the apparatus may transmit a registration complete message (e.g., registration complete). In the RM-registered state, the AMF may transmit the CUC message (e.g., UE configuration update command) according to the registration request message. That is, the AMF may transmit the requested CUC IEs to the apparatus. Then, the apparatus may transmit the configuration update complete message (e.g., UE configuration update complete) to the AMF.

FIG. 4 illustrates an example scenario 400 for a payload container type IE in accordance with implementations of the present disclosure. Referring to FIG. 4, the payload container type IE may comprise the request CSC parameter container corresponding to the payload container type value (1 1 0 1).

FIG. 5 illustrates an example scenario 500 for the request CSC parameter container in accordance with implementations of the present disclosure. Referring to FIG. 5, the request CSC parameter container may comprise the length of the request CUC parameter container in the octet xi+1. The request CSC parameter container may also comprise the numbers of IEI list (e.g., Request IE 4, Request IE 3, Request IE 2, and Request IE 1 in the octet xi+3, and Request IE 7, Request IE 6, Request IE 5, and Request IE 4 in the octet xi+4). The request CSC parameter container may further comprise the request IEs of CUC in the octet y.

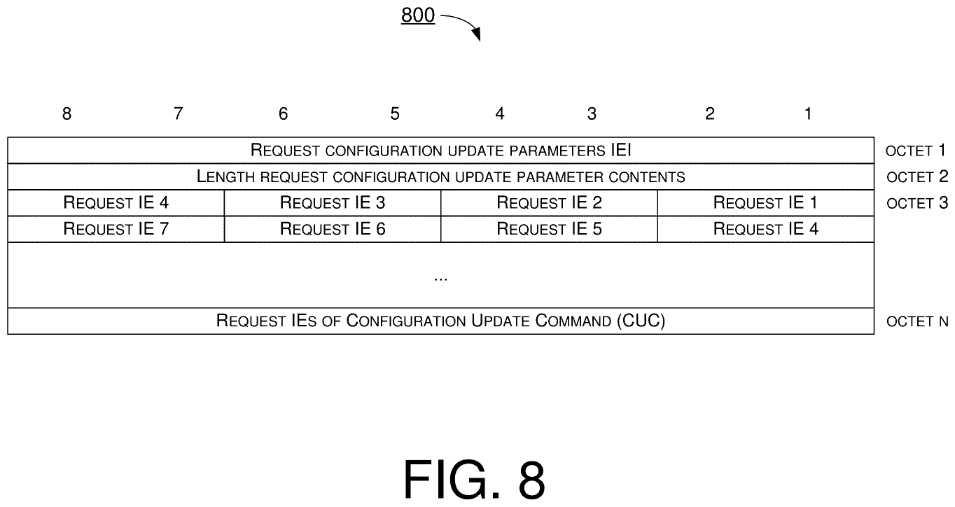

Under a second proposed scheme for the request message transmitted in the RM-registered state, the request message may comprise a configuration update request message, and the configuration update request message may comprise a request list of IEI values (e.g., the table shown in FIG. 8). Specifically, the apparatus may transmit the configuration update request message (e.g., the UE configuration update request) actively to acquire the information assigned in the configuration update command. The request list of IEI values specified in the configuration update request may be an identical list of the information assigned in the configuration update command. In an event that the network (e.g., the AMF of the network) receives the configuration update request message in the MM-registered state, the network (e.g., the AMF of the network) may transmit the CUC message (or UE configuration update command) to the apparatus according to the configuration update request. That is, the configuration update command may comprise the request information in the configuration update request message.

FIG. 6 illustrates an example scenario 600 for requesting configuration under the second proposed scheme, with the request message transmitted in the RM-registered state, in accordance with implementations of the present disclosure. Scenario 600 involves an apparatus (e.g., a UE) and a network node (e.g., a (macro/micro) base station) which may be an AMF of a wireless network (e.g., an LTE network, a 5G/NR network, an IoT network, or a 6G network). Referring to FIG. 6, in the RM-registered state, the apparatus may transmit the configuration update request message (e.g., UE configuration update request) to the AMF. Then, the AMF may transmit the CUC message (e.g., UE configuration update command) according to the configuration update request message. That is, the AMF may re-transmit the requested CUC IEs to the apparatus. Then, the apparatus may transmit the configuration update complete message (e.g., UE configuration update complete) to the AMF.

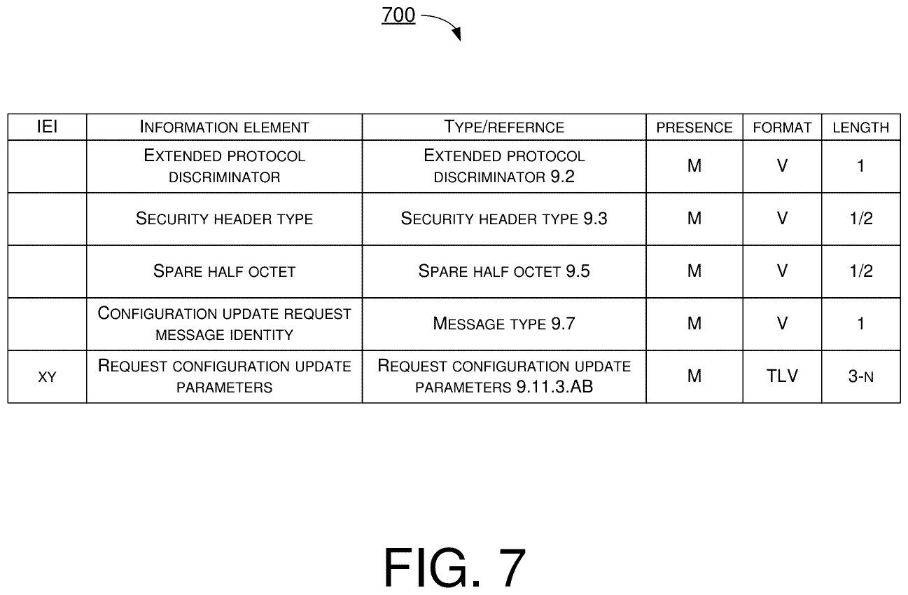

FIG. 7 illustrates an example scenario 700 for the configuration update request message in accordance with implementations of the present disclosure. Referring to FIG. 7, the configuration update request message may comprise the contents of IEI, information element (e.g., extended protocol discriminator, security header type, spare half octet, configuration update request message identity, and request configuration update parameters), type/reference (e.g., extended protocol discriminator 9.2, security header type 9.3, spare half octet 9.5, message type 9.7, and request configuration update parameters 9.11.3 AB), presence (e.g., M), format (e.g., V and TLV), and length (e.g., 1, ½, ½, 1, and 3-n).

FIG. 8 illustrates an example scenario 800 for the request configuration update parameters information element in accordance with implementations of the present disclosure. Referring to FIG. 8, the request configuration update parameters information element may comprise request configuration update parameters IEI in the octet 1. The request configuration update parameters information element may also comprise the length of the request configuration update parameter contents in the octet 2. The request configuration update parameters information element may further comprise the numbers of IEI list (e.g., Request IE 4, Request IE 3, Request IE 2, and Request IE 1 in the octet 3, and Request IE 7, Request IE 6, Request IE 5, and Request IE 4 in the octet 4). The request configuration update parameters information element may further comprise the request IEs of CUC in the octet n.

According to the implementations of the present disclosure, the request message may be transmitted in an RM-deregistered state, and the CUC message may be received in an MM-deregistered state. According to an implementation of the present disclosure, the request message may comprise a registration request message (e.g., registration request). The registration request message may comprise a request list of IEI values in a request CUC parameter container. Specifically, the apparatus may transmit the registration request message with the request CUC parameter container actively to acquire the information assigned in the CUC message (e.g., UE configuration update command). In an event that the network (e.g., the AMF of the network) receives the request CUC parameter container in the payload container IE of the registration request message in the MM-deregistered state, the network (e.g., the AMF of the network) may transmit the CUC message (e.g., UE configuration update command) according to the registration request message. That is, the CUC message (e.g., UE configuration update command) may comprise the request information in the registration request message.

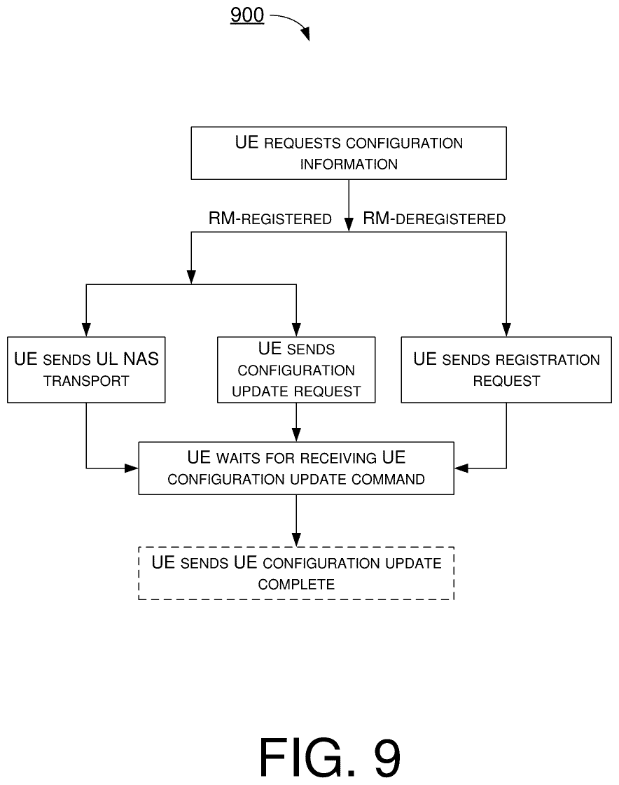

FIG. 9 illustrates an example scenario 900 for the request configuration update procedure in accordance with implementations of the present disclosure. Scenario 900 involves an apparatus (e.g., a UE) and a network node (e.g., a (macro/micro) base station) which may be an AMF of a wireless network (e.g., an LTE network, a 5G/NR network, an IoT network, or a 6G network). Referring to FIG. 9, the UE may request configuration information (i.e., transmit the request message). In an implementation, in an event that the UE is in the RM-registered state, the UE may transmit (or send) the UL NAS transport message to the AMF to request the configuration information. That is, the value of the “request CUC container IE” is true (i.e., “request CUC container IE”=true). Then, the UE may wait for the UE configuration update command from the AMF. In addition, the UE may transmit the configuration update complete to the AMF.

Referring to FIG. 9, in another implementation, in an event that the UE is in the RM-registered state, the UE may transmit (or send) the UE configuration update request to the AMF to request the configuration information. Then, the UE may wait for the UE configuration update command from the AMF. In addition, the UE may transmit the configuration update complete to the AMF.

Referring to FIG. 9, in another implementation, in an event that the UE is in the RM-deregistered state, the UE may transmit (or send) the initial registration request to the AMF to request the configuration information. That is, the value of the “request CUC container IE” is true (i.e., “request CUC container IE”=true). Then, the UE may wait for the UE configuration update command from the AMF. In addition, the UE may transmit the configuration update complete to the AMF.

### Illustrative Implementations

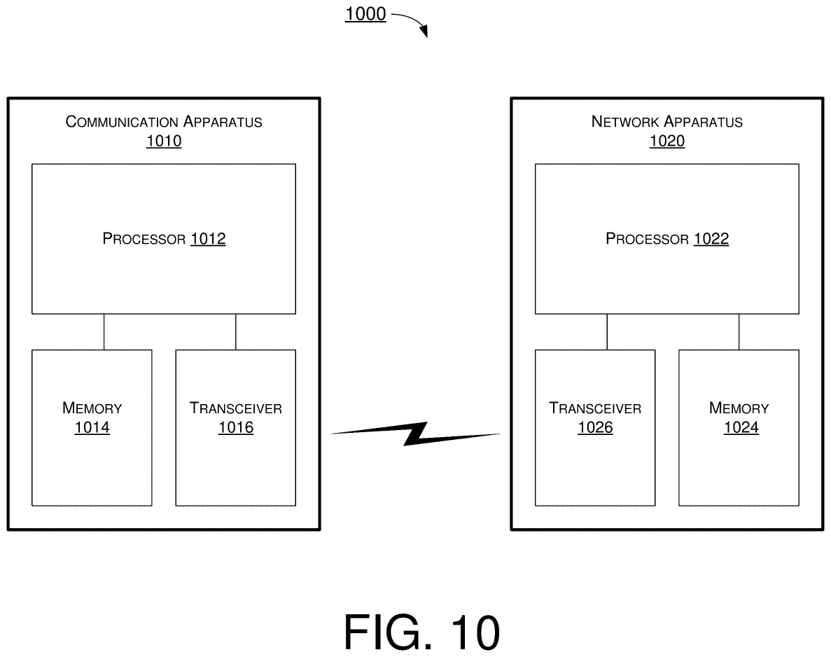

FIG. 10 illustrates an example communication system 1000 having at least an example communication apparatus 1010 and an example network apparatus 1020 in accordance with an implementation of the present disclosure. Each of communication apparatus 1010 and network apparatus 1020 may perform various functions to implement schemes, techniques, processes and methods described herein pertaining to requesting configuration update, including the various schemes described above with respect to various proposed designs, concepts, schemes and methods described above and with respect to user equipment and network apparatus in mobile communications, including scenarios/schemes described above as well as process 1100 and process 1200 described below.

Communication apparatus 1010 may be a part of an electronic apparatus, which may be a UE such as a portable or mobile apparatus, a wearable apparatus, a wireless communication apparatus or a computing apparatus. For instance, communication apparatus 1010 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 1010 may also be a part of a machine type apparatus, which may be an IoT, NB-IoT, eMTC, IIoT UE such as an immobile or a stationary apparatus, a home apparatus, a roadside unit (RSU), a wire communication apparatus or a computing apparatus. For instance, communication apparatus 1010 may be implemented in a smart thermostat, a smart fridge, a smart door lock, a wireless speaker or a home control center. Alternatively, communication apparatus 1010 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 1010 may include at least some of those components shown in FIG. 10 such as a processor 1012, for example. Communication apparatus 1010 may further include one or more other components not pertinent to the proposed schemes of the present disclosure (e.g., internal power supply, display device and/or user interface device), and, thus, such component(s) of communication apparatus 1010 are neither shown in FIG. 10 nor described below in the interest of simplicity and brevity.

Network apparatus 1020 may be a part of an electronic apparatus, which may be a network node such as a satellite, a BS, a small cell, a router or a gateway of an IoT network. For instance, network apparatus 1020 may be implemented in a satellite or an eNB/gNB/TRP in a 4G/5G/B5G/6G, NR, IoT, NB-IoT or IIoT network. Alternatively, network apparatus 1020 may be implemented in the form of one or more IC chips such as, for example and without limitation, one or more single-core processors, one or more multi-core processors, or one or more RISC or CISC processors. Network apparatus 1020 may include at least some of those components shown in FIG. 10 such as a processor 1022, for example. Network apparatus 1020 may further include one or more other components not pertinent to the proposed scheme of the present disclosure (e.g., internal power supply, display device and/or user interface device), and, thus, such component(s) of network apparatus 1020 are neither shown in FIG. 10 nor described below in the interest of simplicity and brevity.

In one aspect, each of processor 1012 and processor 1022 may be implemented in the form of one or more single-core processors, one or more multi-core processors, or one or more CISC processors. That is, even though a singular term “a processor” is used herein to refer to processor 1012 and processor 1022, each of processor 1012 and processor 1022 may include multiple processors in some implementations and a single processor in other implementations in accordance with the present disclosure. In another aspect, each of processor 1012 and processor 1022 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1012 and processor 1022 is a special-purpose machine specifically designed, arranged and configured to perform specific tasks, including requesting configuration update, in a device (e.g., as represented by communication apparatus 1010) and a network node (e.g., as represented by network apparatus 1020) in accordance with various implementations of the present disclosure.

In some implementations, communication apparatus 1010 may also include a transceiver 1016 coupled to processor 1012 and capable of wirelessly transmitting and receiving data. In some implementations, transceiver 1016 may be capable of wirelessly communicating with different types of UEs and/or wireless networks of different radio access technologies (RATs). In some implementations, transceiver 1016 may be equipped with a plurality of antenna ports (not shown) such as, for example, four antenna ports. That is, transceiver 1016 may be equipped with multiple transmit antennas and multiple receive antennas for multiple-input multiple-output (MIMO) wireless communications. In some implementations, network apparatus 1020 may also include a transceiver 1026 coupled to processor 1022. Transceiver 1026 may include a transceiver capable of wirelessly transmitting and receiving data. In some implementations, transceiver 1026 may be capable of wirelessly communicating with different types of UEs of different RATs. In some implementations, transceiver 1026 may be equipped with a plurality of antenna ports (not shown) such as, for example, four antenna ports. That is, transceiver 1026 may be equipped with multiple transmit antennas and multiple receive antennas for MIMO wireless communications.

In some implementations, communication apparatus 1010 may further include a memory 1014 coupled to processor 1012 and capable of being accessed by processor 1012 and storing data therein. In some implementations, network apparatus 1020 may further include a memory 1024 coupled to processor 1022 and capable of being accessed by processor 1022 and storing data therein. Each of memory 1014 and memory 1024 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1014 and memory 1024 may include a type of read-only memory (ROM) such as mask ROM, programmable ROM (PROM), erasable programmable ROM (EPROM) and/or electrically erasable programmable ROM (EEPROM). Alternatively, or additionally, each of memory 1014 and memory 1024 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 1010 and network apparatus 1020 may be a communication entity capable of communicating with each other using various proposed schemes in accordance with the present disclosure. For illustrative purposes and without limitation, descriptions of capabilities of communication apparatus 1010, as a UE, and network apparatus 1020, as a network node (e.g., TRP), are provided below with process 1100 and process 1200.

### Illustrative Processes

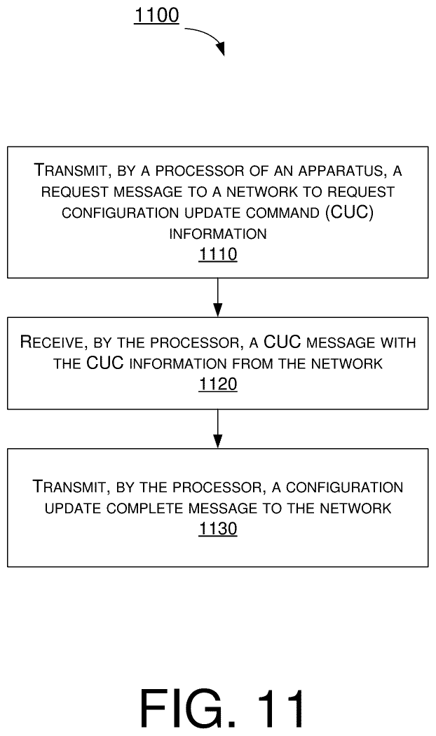

FIG. 11 illustrates an example process 1100 in accordance with an implementation of the present disclosure. Process 1100 may be an example implementation of above scenarios/schemes, whether partially or completely, with respect to requesting configuration update with the present disclosure. Process 1100 may represent an aspect of implementation of features of communication apparatus 1010. Process 1100 may include one or more operations, actions, or functions as illustrated by one or more of blocks 1110, 1120, and 1130. Although illustrated as discrete blocks, various blocks of process 1100 may be divided into additional blocks, combined into fewer blocks, or eliminated, depending on the desired implementation. Moreover, the blocks of process 1100 may be executed in the order shown in FIG. 11 or, alternatively, in a different order. Solely for illustrative purposes and without limitation, process 1100 is described below in the context of communication apparatus 1010. Process 1100 may begin at block 1110.

At block 1110, process 1100 may involve processor 1012 of communication apparatus 1010 transmitting, via transceiver 1016, a request message to a network to request CUC information. Process 1100 may proceed from block 1110 to block 1120.

At block 1120, process 1100 may involve processor 1012 of communication apparatus 1010 receiving, via transceiver 1016, a CUC message with the CUC information from the network. Process 1100 may proceed from block 1120 to block 1130.

At block 1130, process 1100 may involve processor 1012 of communication apparatus 1010 transmitting, via transceiver 1016, a configuration update complete message to the network.

In some implementations, the request message may be transmitted in an RM-registered state, and the CUC message may be received in an MM-registered state.

In some implementations, the request message may comprise a UL NAS transport message, and the UL NAS transport message may comprise a request list of IEI values in a request CUC parameter container.

In some implementations, a payload container type IE may comprise the request CUC parameter container.

In some implementations, the request message may comprise a configuration update request message, and the configuration update request message may comprise a request list of IEI values.

In some implementations, the request message may be transmitted in an RM-deregistered state, and the CUC message may be received in an MM-deregistered state.

In some implementations, the request message may comprise a registration request message, and the registration request message may comprise a request list of IEI values in a request CUC parameter container.

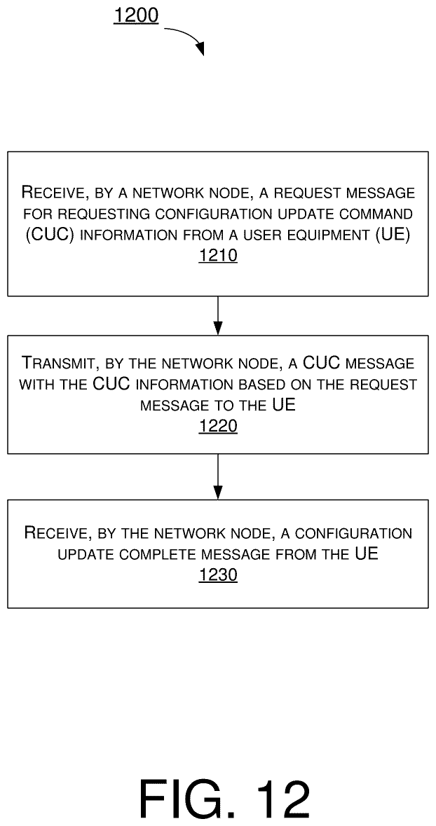

FIG. 12 illustrates an example process 1200 in accordance with another implementation of the present disclosure. Process 1200 may be an example implementation of above scenarios/schemes, whether partially or completely, with respect to requesting configuration update with the present disclosure. Process 1200 may represent an aspect of implementation of features of network apparatus 1020. Process 1200 may include one or more operations, actions, or functions as illustrated by one or more of blocks 1210, 1220, and 1230. Although illustrated as discrete blocks, various blocks of process 1200 may be divided into additional blocks, combined into fewer blocks, or eliminated, depending on the desired implementation. Moreover, the blocks of process 1200 may be executed in the order shown in FIG. 12 or, alternatively, in a different order. Solely for illustrative purposes and without limitation, process 1200 is described below in the context of network apparatus 1020. Process 1200 may begin at block 1210.

At block 1210, process 1200 may involve processor 1022 of network apparatus 1020 receiving, via transceiver 1026, a request message for requesting CUC information from a UE. Process 1200 may proceed from block 1210 to block 1220.

At block 1220, process 1200 may involve processor 1022 transmitting, via transceiver 1026, a CUC message with the CUC information based on the request message to the UE. Process 1200 may proceed from block 1220 to block 1230.

At block 1230, process 1200 may involve processor 1022 receiving, via transceiver 1026, a configuration update complete message from the UE.

In some implementations, the request message may be received in an RM-registered state, and the CUC message may be transmitted in an MM-registered state.

In some implementations, the request message may comprise a UL NAS transport message, and the UL NAS transport message may comprise a request list of IEI values in a request CUC parameter container.

In some implementations, a payload container type IE may comprise the request CUC parameter container.

In some implementations, the request message may comprise a configuration update request message, and the configuration update request message may comprise a request list of IEI values.

In some implementations, the request message may be received in an RM-deregistered state, and the CUC message may be transmitted in an MM-deregistered state.

In some implementations, the request message may comprise a registration request message, and the registration request message may comprise a request list of IEI values in a request CUC parameter container.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of an apparatus, a request message to a network to request configuration update command (CUC) information;
receiving, by the processor, a CUC message with the CUC information from the network; and
transmitting, by the processor, a configuration update complete message to the network.

2. The method of claim 1, wherein the request message is transmitted in a registration management (RM)-registered state, and wherein the CUC message is received in a mobility management (MM)-registered state.

3. The method of claim 2, wherein the request message comprises an uplink (UL) non-access stratum (NAS) transport message, and wherein the UL NAS transport message comprises a request list of information element identifier (IEI) values in a request CUC parameter container.

4. The method of claim 3, wherein a payload container type information element (IE) comprises the request CUC parameter container.

5. The method of claim 2, wherein the request message comprises a configuration update request message, and wherein the configuration update request message comprises a request list of information element identifier (IEI) values.

6. The method of claim 1, wherein the request message is transmitted in a registration management (RM)-deregistered state, and wherein the CUC message is received in a mobility management (MM)-deregistered state.

7. The method of claim 6, wherein the request message comprises a registration request message, and wherein the registration request message comprises a request list of information element identifier (IEI) values in a request CUC parameter container.

8. A method, comprising:
receiving, by a network node, a request message for requesting configuration update command (CUC) information from a user equipment (UE);
transmitting, by the network node, a CUC message with the CUC information based on the request message to the UE; and
receiving, by the network node, a configuration update complete message from the UE.

9. The method of claim 8, wherein the request message is received in a registration management (RM)-registered state, and wherein the CUC message is transmitted in a mobility management (MM)-registered state.

10. The method of claim 9, wherein the request message comprises an uplink (UL) non-access stratum (NAS) transport message, and wherein the UL NAS transport message comprises a request list of information element identifier (IEI) values in a request CUC parameter container.

11. The method of claim 10, wherein a payload container type information element (IE) comprises the request CUC parameter container.

12. The method of claim 9, wherein the request message comprises a configuration update request message, and wherein the configuration update request message comprises a request list of information element identifier (IEI) values.

13. The method of claim 8, wherein the request message is received in a registration management (RM)-deregistered state, and wherein the CUC message is transmitted in a mobility management (MM)-deregistered state.

14. The method of claim 13, wherein the request message comprises a registration request message, and wherein the registration request message comprises a request list of information element identifier (IEI) values in a request CUC parameter container.

15. An apparatus, comprising:
a transceiver which, during operation, wirelessly communicates with a network; and
a processor communicatively coupled to the transceiver such that, during operation, the processor performs operations comprising:
transmitting, via the transceiver, a request message to the network to request configuration update command (CUC) information;
receiving, via the transceiver, a CUC message with the CUC information from the network; and
transmitting, via the transceiver, a configuration update complete message to the network.

16. The apparatus of claim 15, wherein the request message is transmitted in a registration management (RM)-registered state, and wherein the CUC message is received in a mobility management (MM)-registered state.

17. The apparatus of claim 16, wherein the request message comprises an uplink (UL) non-access stratum (NAS) transport message, wherein the UL NAS transport message comprises a request list of information element identifier (IEI) values in a request CUC parameter container, and wherein a payload container type information element (IE) comprises the request CUC parameter container.

18. The apparatus of claim 16, wherein the request message comprises a configuration update request message, and wherein the configuration update request message comprises a request list of information element identifier (IEI) values.

19. The apparatus of claim 15, wherein the request message is transmitted in a registration management (RM)-deregistered state, and wherein the CUC message is received in a mobility management (MM)-deregistered state.

20. The method of claim 19, wherein the request message comprises a registration request message, and wherein the registration request message comprises a request list of information element identifier (IEI) values in a request CUC parameter container.
